(19) United States
(12) Patent Application Publication
(10) Pub. No.: US 2025/0017426 A1
(43) Pub. Date: Jan. 16, 2025

(54) UTENSIL WITH DISPENSING APPARATUS AND MULTIPLE ATTACHMENTS

(71) Applicants: Lonzell Montgomery, New York, NY (US); Kevin Garcia, New York, NY (US)

(72) Inventors: Lonzell Montgomery, New York, NY (US); Kevin Garcia, New York, NY (US)

(21) Appl. No.: 18/772,417

(22) Filed: Jul. 15, 2024

Related U.S. Application Data
(60) Provisional application No. 63/526,678, filed on Jul. 14, 2023.

(51) Int. Cl. A47J 43/28

(52) U.S. Cl. CPC A47J 43/288

(57) ABSTRACT

The present disclosure provides for a utensil that contains a dispensing mechanism therein. The dispensing mechanism may be present in the handle of the utensil. Furthermore, the present disclosure provides a mechanism to load various herbs, spices, and the like into the dispensing mechanism. This allows for both the dispensing mechanism and utensil to be contained within one easy-to-use and hold package.

### CLAIM OF PRIORITY

This application claims priority to U.S. Application Ser. No. 63/526,678 filed on Jul. 14, 2023, the contents of which are herein fully incorporated by reference in its entirety.

### FIELD OF THE EMBODIMENTS

This field of the embodiments of the present invention relates to various utensils that contain dispensing-type structures. In particular, the present invention and its embodiments relate to kitchen apparatus that can also dispense various spices such as but not limited to salt, pepper, and dried herbs.

### BACKGROUND OF THE EMBODIMENTS

Outdoor grilling and other types of cooking outside the confines of a conventional kitchen are quite popular, especially in the summertime when the weather is conducive for such cooking. Unfortunately, outdoor grilling typically requires the availability of a considerable number of items to the grill. Such items may include various tools or utensils, charcoal, matches, lighter fluid, propane, condiments, seasonings, and the food itself. When these items are stored at or near the cooking area, it is a simple matter to retrieve the necessary items when needed. Further, if one is traveling to do cooking then all these accessories must be transported and then carried to the cooking location. For example, the items are often to be carried from a storage area in a kitchen to an outdoor area such as a deck or backyard, or must be transported to a park, campsite, or other remote outdoor location. Not only is it frequently difficult to carry all the necessary items, but because so many items are involved, it is also frequently difficult for the cook to remember everything. Thus, a need exists to minimize the number of separate items that must be remembered and carried from a storage area to a cooking site.

For example, US2007/0080176 pertains to a cooking utensil having a seasoning device built into its handle. The dispenser is created from a hollow portion of the utensil handle and includes a lid and perforations for loading and dispensing the seasoning in particulate form therefrom. The dispenser portion of the handle may be separated by the user from the rest of the handle by unscrewing or otherwise disengaging the two portions from one another. The invention may be used in any cooking utensil, and two or more utensils with built-in dispensers may be incorporated into a set of utensils, such as a set of grill tools.

US2008/0289189 pertains to a utensil that can be utilized to slice pizzas and dispense condiments. The utensil includes a handle and a rotating circular blade for cutting, for example, a pizza into multiple slices. Additionally, the utensil includes one or more compartments, which can be used to hold and dispense various items such as condiments. The compartment(s) can be sealed with tape, aluminum, or a snap-fit cover to secure one or more items held within the compartment(s). The condiments may be provided directly in the compartments or may be provided in a sealed package or envelope that is received in a respective compartment. Additionally, the compartment(s) can be fitted with a perforated covering to allow for the gradual dispensing of one or more items held in the compartment. Furthermore, the circular blade of the utensil can be formed with a wavy edge, rather than a straight edge, to provide greater strength to the blade. The utensil can be formed entirely in plastic to allow the utensil to be more easily disposed and/or recycled.

Thus, various devices are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present application and its embodiments provide for utensils with a dispensing apparatus integrated therewith. As described herein, the present invention and its embodiments provide for a multifunctional cooking utensil or tool that allows a user to perform two or more cooking functions either simultaneously or independently of one another. In at least one embodiment, the shaft or handle of the utensil has at least one hollow and a mating mechanism(s) on each of its ends to incorporate various utensil attachments as well as the dispensing compartment. In further embodiments, the attachments and the dispensing portion may also contain mating mechanisms to be mounted and incorporated into one of the ends of the dual-sided shaft or handle.

For example, a user of the utensil of the present invention may attach a spatula to one end of the shaft and a shaker attachment on the other end of the shaft. The user will then have the ability to utilize the spatula portion to flip or rotate a food item as well as the ability to apply spices and/or herbs to the food item. In yet other embodiments, a user can replace the dispensing attachment with a forked attachment thereby allowing more flexibility in how the food is manipulated via the spatula attachment and forked attachments while cooking without relying on additional utensils. Overall, the embodiments of the present invention will make cooking, grilling, and the like easier and more manageable for all cooks, chefs, and tailgaters.

In at least one embodiment of the present invention, there is a dispensing utensil having a handle with a first end and a second end with the handle at least one hollow therein, wherein each of the first end and the second end have threading on an outer surface of the handle; a compartment configured to be removably coupled to the handle; a divider configured to divide the compartment into more than one sub-compartment; a covering having a top surface and a bottom surface, the covering configured to selectively cover an opening of the compartment, wherein the covering has a plurality of openings traversing from the top surface to the bottom surface of the covering; a first attachment configured to be coupled to the threading of the first end of the handle; a second attachment configured to be coupled to the threading of the second end of the handle. The present invention and its embodiments provide at least the following and other objects of the present invention.

In yet another embodiment of the present invention, there is a dispensing utensil having a hollow with a first end, a second end, and an interior, wherein each of the first end and the second end have threading on an inner surface of the hollow handle, and wherein the second end has threading on an outer surface of the hollow handle; a compartment configured to be removably coupled to the hollow handle; a divider configured to divide the compartment into at least three sub-compartments, wherein the divider spans a length of the compartment; a covering having a top surface and a bottom surface, the covering configured to selectively cover an opening of the compartment, wherein the covering has a plurality of openings traversing from the top surface to the bottom surface of the covering; a first attachment configured to be coupled to the threading of the first end of the handle; and a second attachment configured to be coupled to the threading of the second end of the handle.

In yet another embodiment of the present invention, there is a dispensing utensil system having a dispensing tool with a handle having a first end and a second end with the handle at least one hollow therein, wherein each of the first end and the second end has threading; a compartment configured to coupled to the handle; a divider configured to divide the compartment into more than one sub-compartment; a covering having a top surface and a bottom surface, the covering configured to selectively cover an opening of the compartment, wherein the covering has a plurality of openings traversing from the top surface to the bottom surface of the covering; a first attachment configured to be coupled to the threading of the first end of the handle; a second attachment configured to be coupled to the threading of the second end of the handle; and a funnel configured to attach to the opening of the compartment of the dispensing tool thereby allowing at least one material to be inserted into the compartment of the dispensing tool.

It is an object of the present invention to provide a utensil that is lightweight and easy to use.

It is an object of the present invention to provide a utensil that has a variety of attachments that can be used with the utensil.

It is an object of the present invention to provide a utensil that allows for a variety of cooking methods to be assisted by a singular utensil.

It is an object of the present invention to provide a utensil that can apply herbs and/or spices to food.

It is an object of the present invention to provide a utensil that has interchangeable components.

It is an object of the present invention to provide a utensil that reduces the number of utensils required for cooking thereby freeing up a user's hands and the cooking space.

It is an object of the present invention to provide a utensil that is food-safe.

It is an object of the present invention to provide a utensil that is sufficiently heat resistant.

### BRIEF DESCRIPTION OF THE DRAWINGS

FIG. 1 shows an exploded view of the first embodiment of the present invention.

FIG. 2A shows an embodiment of the present invention in an assembled format.

FIG. 2B shows an embodiment of the present invention in a disassembled format.

FIG. 2C shows a dual-sided hollow shaft/shaker in accordance with an embodiment of the present invention.

FIG. 3 shows a spice handle/shaker in accordance with an embodiment of the present invention.

FIG. 4 shows the baster tool attachment in accordance with an embodiment of the present invention.

FIG. 5 shows a pizza cutter attachment in accordance with an embodiment of the present invention.

FIG. 6 shows a knife attachment in accordance with an embodiment of the present invention.

FIG. 7 shows a spoon attachment in accordance with an embodiment of the present invention.

FIG. 8 shows a strainer attachment in accordance with an embodiment of the present invention.

FIG. 9 shows a spatula attachment in accordance with an embodiment of the present invention.

FIG. 10 shows a forked attachment in accordance with an embodiment of the present invention.

FIG. 11 shows a brush attachment in accordance with an embodiment of the present invention.

FIG. 12 shows a stirring attachment in accordance with an embodiment of the present invention.

FIG. 13 shows a tenderizing attachment in accordance with an embodiment of the present invention.

FIG. 14 shows a whisk attachment in accordance with an embodiment of the present invention.

FIG. 15 shows various combinations of attachments that may be used under the purview of the embodiments of the present invention.

FIG. 16A shows a first view of a funnel configured to assist in pouring herbs and/or spices into a handle or shaft of the present invention.

FIG. 16B shows a second view of a funnel configured to assist in pouring herbs and/or spices into a handle or shaft of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

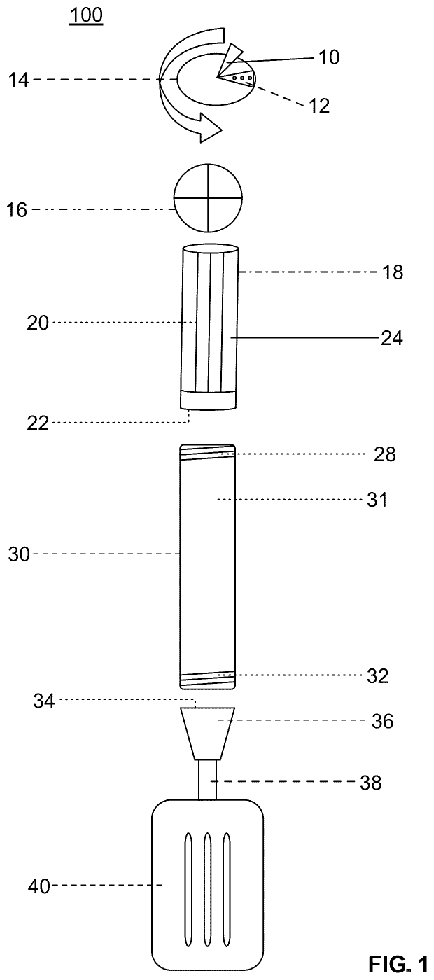

Referring now to FIG. 1, there is an exploded view of an embodiment of the present invention featuring a utensil 100. Generally included are a twist-top 14, opening 12, cover 10, shaker selector 16, compartment 18, divider 20, sub-compartments 24, compartment threading 22, handle 30, first handle threading 28, markings 31, second handle threading 32, attachment threading 34, attachment receiving end 36, neck 38, and tool 40.

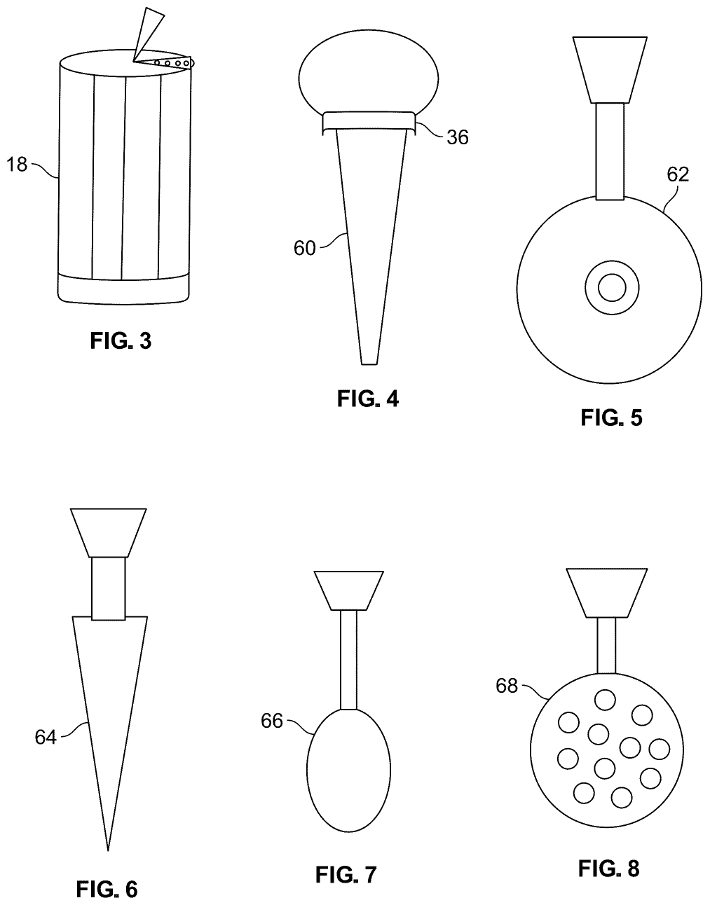

As shown, the utensil 100 is configured to have interchangeable and removable attachments at a first end (first attachments) and a second end (second attachments). The utensil 100 is generally configured for use in the kitchen and/or for cooking food. The first attachment and/or second attachment may include those attachments described further herein, particularly in relation to FIGS. 3-14, and may also include ice cream scoops, tongs, and other various cooking utensils desired by the end user.

The handle 30 is the “central” portion of the utensil 100 to which the other components of the utensil 100 interact with or attach/couple thereto. The handle 30 is preferably hollow, transparent, and may have one or more separate and distinct hollows therein. In other embodiments, the handle 30 is a completely hollow tubular structure. The handle 30 may have markings 31 thereon. The markings 31 may be the name of the product or other insignia to identify components or portions of the utensil 100. Further, there is a first set of threading 28 at a top of the handle 30 and a second set of threading 32 at a bottom of the handle 30. The threading 28, 32 may be on an outer or inner surface of the handle 30. Generally, as will be described herein, the handle 30 functions as a storage compartment that can store liquids, solids, and/or electronic circuits. For example, skewers, sauces, nozzles, push triggers, etc., and the like or some combination thereof. For electronic circuits, such circuits will relate information through an electronic display screen and speaker to communicate information such as temperature (both ambient environment and that of the food being cooked), timer, music, etc.

In a preferred embodiment, there is a compartment 18 which contains a divider 20 and subcompartments 24. The compartment 18 similar to the handle 30 is preferably transparent or translucent such that the matter contained within the compartment 18 is visible from an exterior vantage point. At first end of the compartment 18 has an opening or aperture and a second end is closed or sealed. At the second end, there is preferably threading 22 configured to couple to threading 28, 32 as needed thereby coupling the handle 30 to the compartment 18.

The compartment 18 has a divider 20 therein to divide the interior volume of the compartment 18 into subcompartments 24. The divider 20 preferably divides the compartment 18 into two or more subcompartments 24 and preferably four subcompartments 24. The divider 20 may be removable and different dividers 20 (size, number of divisions, etc.) may be inserted and secured in the compartment 18. The divider 20 may slide into grooves on an interior surface of the compartment, twist, and lock, and use another mechanism to secure the divider 20 once inserted into the compartment 18. In combination with the sealed end of the compartment 18, the divider creates subcompartments 24 that have one closed end, one open end, and sidewall(s).

To further utilize the compartment 18, there is a shaker selector 16, twist-top 14, opening 12, and cover 10. The shaker selector 16 is configured to fit, via threading, friction fit, and the like, to the open end of the compartment 18. The shaker selector 16 has one or more regions that have at least one and preferably a plurality of apertures. The plurality of apertures are designed to allow various herbs, spices, and the like to be dispensed from the compartment 18 or subcompartment 24 onto the foods or other locations desired by the end user. In one example, the shaker selector 16 has one region with one aperture, one region with two or more apertures, another region with five or more apertures, and another region with ten or more apertures. In at least one embodiment, one region has no apertures. The numbers of regions preferably align with the number of subcompartments 24 in the compartment 18. The shaker selector 16 may further be rotated or otherwise manipulated to align certain regions over certain subcompartments 24.

A twist-top 14 having a cover 10 (to selectively cover and uncover the opening 12) and an opening 12 may further be used to cover and preserve the contents of the compartment 18. The twist top 14 preferably friction fits onto the compartment 18 over the shaker selector 16. The twist-top 14 can be twisted or rotated to align the cover 10 and opening 12 with a particular subcompartment 24. This allows for the dispensing of the contents of the aligned subcompartment 24 The twist-top 14 can be utilized with or without the shaker selector 16 as desired. As noted, the compartment 18 may be at least partially transparent thereby allowing one to see if the seasoning is running low or prevent over seasoning of the food items. Opening(s) 12 are integrated on the twist-top 14 for the herbs and/or spices to be released and exit the subcompartments 24.

On an opposite end of the handle 30 (from the compartment 18 or other tool 40) is threading 32 configured to allow for an additional compartment 18 or tool attachment. The attachment threading 34, attachment receiving end 36, neck 38, and tool 40 form the components for this portion of the utensil 100. The attachment receiving end 36 is preferably frustoconical in shape and has an open end with threading 34. The threading 34 is configured to couple to threading 32 of the handle 30. The opposing end of the attachment receiving end 36 has a neck 38 which leads to the tool 40. The neck 38 is a length of material between the tool 40 and the attachment receiving end 36. The neck 38 may be telescoping or flexible to allow for increased use and manipulation of the tool 40 and handle 30 during use. As further described below, the tool 40 may be a working portion of a number of different conventional kitchen and/or cooking implements.

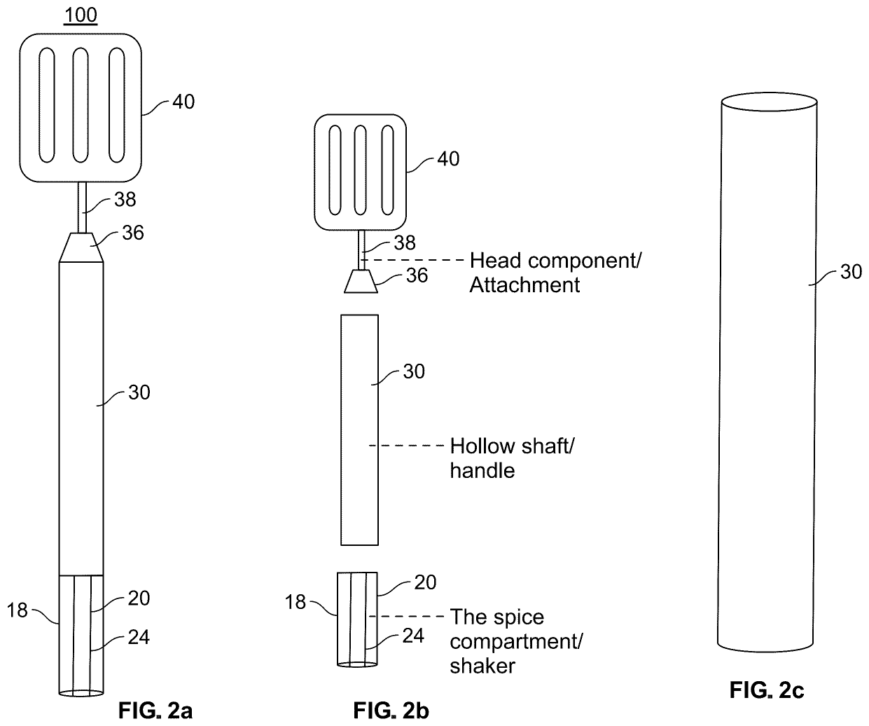

Referring to FIGS. 2A-C, an embodiment of the utensil 100 is shown in both an assembled and disassembled form. Here, the tool 40 is shown as a spatula and further the tool 40 has a neck 38 and attachment receiving end 36. The attachment receiving end 36 is coupled to the handle 30. At an end of the handle 30 opposite the tool 40 is a compartment 18 having a divider 20 which divides the compartment 18 into subcompartments 24 as previously described in FIG. 1.

This shows how each of the first attachment mechanisms and the second attachment mechanism may be coupled and removed from the main handle or shaft portion of the utensil 100. The threading (or other suitable attachment mechanism) allows for simple rotation of the first attachment mechanism and the second attachment mechanism to allow the same to be coupled to the handle or shaft. In other embodiments, other conventional mechanisms of attachment may be used as further described herein.

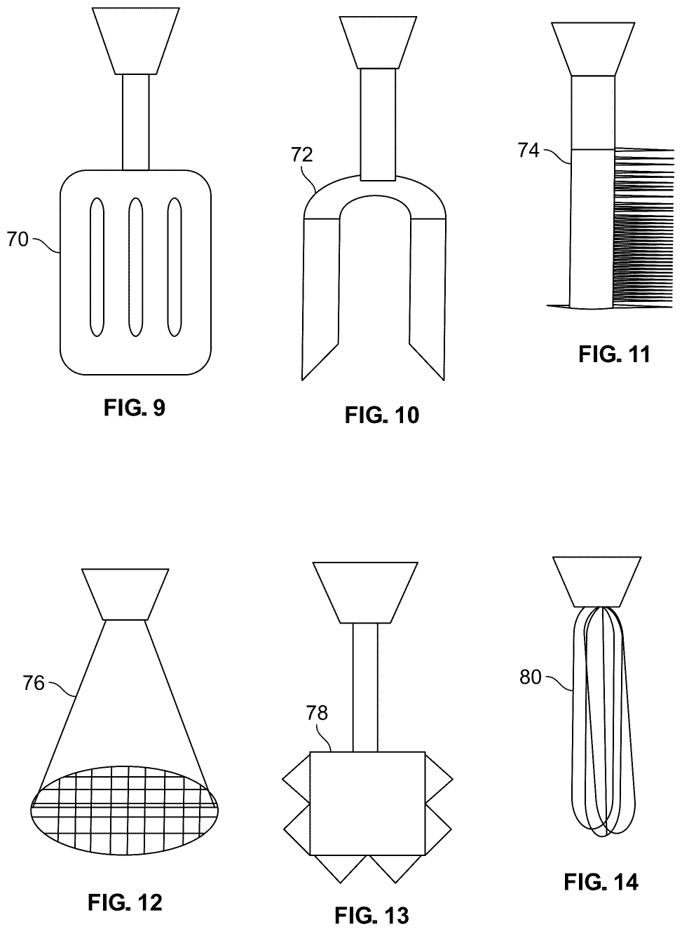

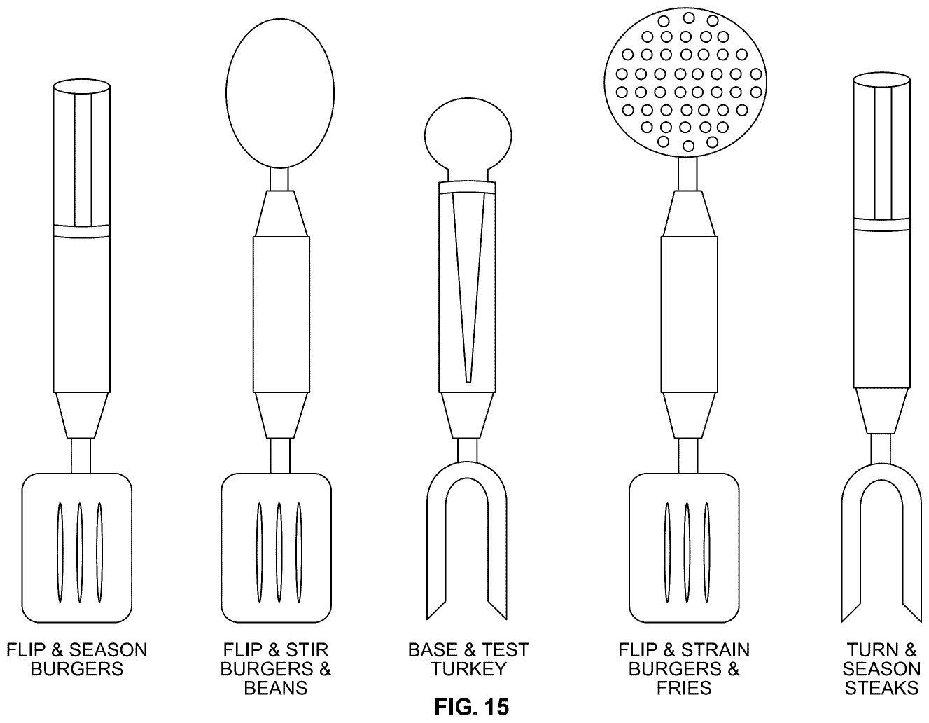

Referring now to FIGS. 3-14, there are varying attachment mechanisms shown. The varying attachment mechanism may be used in any combination with one another. The listing of the exemplary attachment mechanisms herein is not exhaustive and other known mechanisms may be contained under the purview of this invention. FIG. 3 shows a compartment 18 as previously described herein. FIG. 4 shows the baster tool attachment 60. As shown in FIG. 15, the baster tool attachment 60 is configured to have an attachment receiving end 36 that allows for the baster tool attachment 60 to be stored at least partially within the hollow handle 30 when not in use. FIG. 5 shows a pizza cutter attachment 62. FIG. 6 shows a knife attachment 64. FIG. 7 shows a spoon attachment 66. FIG. 8 shows a strainer attachment 68. FIG. 9 shows a spatula attachment 70. FIG. 10 shows a forked attachment 72. FIG. 11 shows a brush attachment 74. FIG. 12 shows a stirring attachment 76. FIG. 13 shows a tenderizing attachment 78. FIG. 14 shows a whisk attachment 80. In at least one embodiment, the attachment mechanisms shown here may include a slanted edge or inwardly curved edge for opening bottles and/or cans. In other embodiments, more traditional bottle and/or can openers may be integrated into the attachment mechanisms.

In FIG. 15, there are several illustrative combinations of potential attachment mechanisms to be used in accordance with the present invention. For example, shown is a spatula and seasoning combination that may be used to cook burgers, a spatula, and stirring combination that may be used to book burgers and stir sauces or other foods, a fork and baster combination that may be used for cooking turkey, a spatula and strainer combination that may be used for cooking burgers and straining French fries, and a fork and seasoning combination that may be used to cook and season steaks or other meats. Again, such combinations are simply illustrative and not exhaustive and other combinations may be utilized within the purview of the present invention.

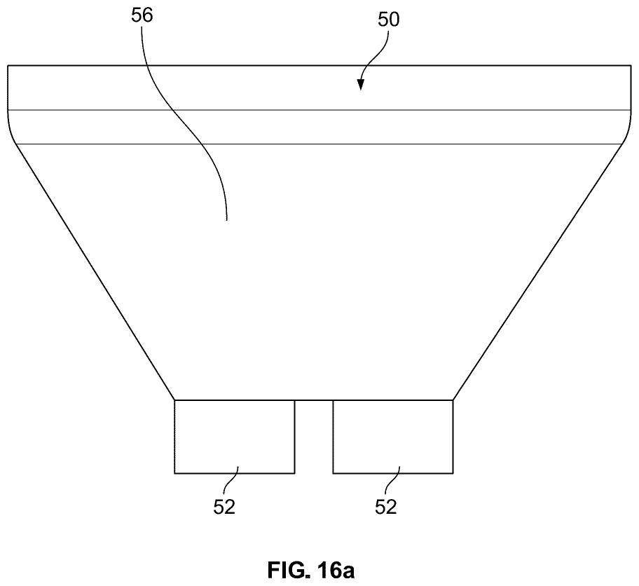

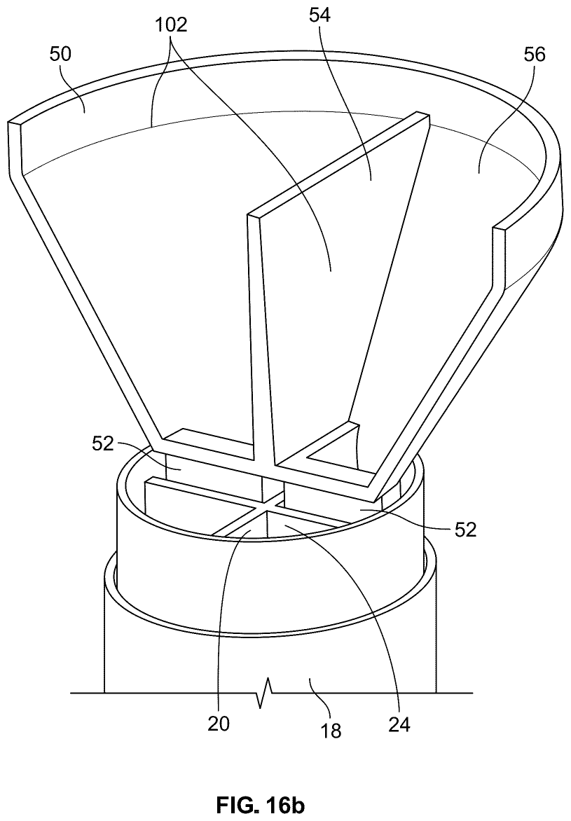

As shown in FIGS. 16A-B, there is a funnel 50 configured to assist with loading herbs and/or spices into the compartment 18 of the present invention. In a preferred embodiment, the funnel 50 has a divider 52 that allows for the separation of the interior 56 of the funnel 50 into multiple sub-compartments 102. The spout or end of the funnel 50 (as opposed to the wider receptacle portion of the funnel) may also have a dividing mechanism or consist of multiple spout portions 52 (preferably one funnel spout for each created subcompartment in the funnel). The multiple spout portions 52 are shaped and sized to fit within the subcompartments 24 created by the divider 20 in the compartment 18 for holding herbs and/or spices. This allows for multiple herbs and/or spices to be individually or simultaneously loaded into differing sub-compartments 102 of the funnel 50 thereby allowing the same to be filled into the herb and/or spice compartment. The funnel 50 may be stored separately from the utensil 100 or in some embodiments may be able to be collapsed or disassembled and stored within the utensil 100 such as in the handle 30.

Although this invention and its embodiments have been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A dispensing utensil comprising:
a handle having a first end and a second end with the handle at least one hollow therein,
wherein each of the first end and the second end have threading;
a compartment configured to be coupled to the handle;
a divider configured to divide the compartment into more than one sub-compartment;
a covering having a top surface and a bottom surface, the covering configured to selectively cover an opening of the compartment,
wherein the covering has a plurality of openings traversing from the top surface to the bottom surface of the covering;
a first attachment configured to be coupled to the threading of the first end of the handle;
a second attachment configured to be coupled to the threading of the second end of the handle.

2. The utensil of claim 1 wherein the first attachment and the second attachment are independently selected from the group consisting of a baster, a pizza cutter, a knife, a spoon, a strainer, a tenderizer, a fork, a brush, a stirrer, an ice cream scoop, tongs, a spatula, a spice container, and a whisk.

3. The utensil of claim 1 further comprising a funnel configured to couple to the opening of the compartment thereby allowing at least one material to be inserted into the compartment.

4. The utensil of claim 1 wherein the divider divides the compartment into four sub-compartments.

5. The utensil of claim 4 wherein each of the four sub-compartments are segregated from another of the four sub-compartments.

6. The utensil of claim 1 wherein the compartment has a first end and a second end with the second end having threading.

7. The utensil of claim 6 wherein the threading of the compartment is configured to engage with threading on an interior surface of the handle.

8. The utensil of claim 1 wherein each of the first attachment and the second attachment has a neck.

9. The utensil of claim 8 wherein the neck is frustoconical in shape.

10. A dispensing utensil comprising:
a hollow handle having a first end, a second end, and an interior,
wherein each of the first end and the second end have threading;
a compartment configured to be coupled to the hollow handle;
a divider configured to divide the compartment into at least three sub-compartments,
wherein the divider spans a length of the compartment;
a covering having a top surface and a bottom surface, the covering configured to selectively cover an opening of the compartment,
wherein the covering has a plurality of openings traversing from the top surface to the bottom surface of the covering;
a first attachment configured to be coupled to the threading of the first end of the handle; and
a second attachment configured to be coupled to the threading of the second end of the handle.

11. The utensil of claim 10 further comprising a shaker selector coupled to the compartment.

12. The utensil of claim 11 wherein the shaker selector has one or more regions having apertures.

13. The utensil of claim 10 wherein the second attachment is a dispensing cover.

14. The utensil of claim 11 wherein the shaker selector is coupled to the compartment via threading or a friction fit.

15. A dispensing utensil system comprising:
a dispensing tool comprising:
a handle having a first end and a second end with the handle at least one hollow therein,
wherein each of the first end and the second end have threading;
a compartment configured to be coupled to the handle;
a divider configured to divide the compartment into more than one sub-compartment;
a covering having a top surface and a bottom surface, the covering configured to selectively cover an opening of the compartment,
wherein the covering has a plurality of openings traversing from the top surface to the bottom surface of the covering;
a first attachment configured to be coupled to the threading of the first end of the handle;
a second attachment configured to be coupled to the threading of the second end of the handle; and
a funnel configured to attach to the opening of the compartment of the dispensing tool thereby allowing at least one material to be inserted into the compartment of the dispensing tool.

16. The system of claim 15 wherein the funnel has a conical portion and an adaptor portion.

17. The system of claim 16 wherein the adaptor portion has a plurality of dispensers configured to engage and fit into each sub-compartment created by the divider.
